(19) United States
(12) Patent Application Publication
(10) Pub. No.: US 2012/0293650 A1
(43) Pub. Date: Nov. 22, 2012

(54) IMAGING SYSTEM AND IMAGE PROCESSING APPARATUS

(75) Inventor: Tomochika Murakami, Ichikawa-shi (JP)

(73) Assignee: CANON KABUSHIKI KAISHA, Tokyo (JP)

(21) Appl. No.: 13/473,150

(22) Filed: May 16, 2012

(30) Foreign Application Priority Data
May 20, 2011 (JP) 2011-113963

(51) Int. Cl. H04N 7/18

(52) U.S. Cl. 348/135; 348/E07.085

(57) ABSTRACT

An imaging system that acquires image data through imaging of an object, includes: an imaging unit having an imaging optical system that forms an image of an object, and an imaging device that captures the image of the object formed by the imaging optical system; a stain method estimation unit that estimates a stain method of the object by analyzing image data of the object as obtained from the imaging unit; and a data reduction processing unit that reduces data volume of image data of the object if the stain method estimated by the stain method estimation unit is a predetermined stain method.

### BACKGROUND OF THE INVENTION

1. Field of the Invention

The present invention relates to an imaging system that acquires image data through imaging of multiple objects, and to an image processing apparatus that processes image data of multiple objects.

2. Description of the Related Art

Virtual slide systems, which enable pathological diagnosis on a display through imaging of test samples that are mounted on slides and through digitization of obtained images, have attracted attention in recent years, in the field of pathology, as substitutes of optical microscopes, which are one of the tools of pathological diagnosis. Digitization of pathological diagnosis images through the use of virtual slide system makes it possible to handle, in the form of digital data, images of test samples from conventional optical microscopy. This affords potential advantages in terms of, for instance, faster remote diagnosis, briefing to patients using digital images, sharing of rare cases, and greater schooling and training efficiency.

In order to realize an operation comparable to that of an optical microscope, but in a virtual slide system, it is necessary to digitize the entire test sample on a slide. Through digitization of the entire test sample, the digital data generated in the virtual slide system can be observed using viewer software that is run on a PC or a workstation. The number of pixels upon digitization of an entire test sample is ordinarily of several hundred of millions to several billions of pixels, which is a very large volume of data.

Although the volume of data generated by the virtual slide system is enormous, images can be observed microscopically (detailed enlarged image) and macroscopically (whole overhead image), through enlargement or reduction in the viewer. This affords various benefits. Low-magnification images to high-magnification images can be instantaneously displayed, at the resolution and magnifications required by the user, through preliminary acquisition of all the necessary information items.

Physicians must ordinarily observe multiple slides in pathological diagnosis. Therefore, a virtual slide system is required that embodies a batch processing functionality so as to enable digitization of a large amount of slides in a short time (for instance, overnight), at the medical care site. That is, the virtual slide system has preferably enhanced throughput (number of processed images per unit time). In order to realize batch processing, a scheme is also required for automatic determination of imaging conditions, without the need for human judgment.

Japanese Patent Application Publication No. 2010-216919 discloses the features of imaging firstly an object in a low-resolution and high-throughput mode, in order to increase the efficiency of batch processing, and changing over to a high definition mode only upon detection of a specific signal within captured images. Japanese Patent Application Publication No. 2009-294463 discloses a method relating to automatic determination of imaging conditions, wherein the method involves estimating the stain method of a specimen on the basis of captured images, and performing color conversion processing that is appropriate for a respective stain method, to achieve thereby images of higher quality for each specimen.

The method of Japanese Patent Application Publication No. 2010-216919 can potentially shorten processing time in cases where the proportion of objects to be imaged at high resolution is small. In the case of batch processing of objects for pathological diagnosis, as described above, all objects (slides) are imaged in principle at high resolution. Therefore, no gains in throughput can be achieved using the method disclosed in Japanese Patent Application Publication No. 2010-216919.

Pathological diagnosis can be roughly divided into histological diagnosis and cytological diagnosis, which differ from each other as regards specimen preparation and observation (diagnosis) purpose. Conventional systems, however, were only capable of performing processing under identical conditions, regardless of the type of object, also in cases where objects for histological diagnosis and objects for cytological diagnosis were mixed. Depending on the object, therefore, generation and recording of image data beyond required specifications (for instance, resolution, image quality, compression rate and so forth) results in lowered processing efficiency on account of the increased data volume. This problem becomes particularly serious as the resolution and size of the images increase. However, information required for observation and diagnosis may be lost when, in order to reduce data volume, resolution and/or image quality are lowered, and the compression rate is increased, across-the-board for all objects.

### SUMMARY OF THE INVENTION

In the light of the above it is an object of the present invention to provide a technology for enhancing throughput upon batch processing of image data of multiple objects.

The present invention in its first aspect provides an imaging system that acquires image data through imaging of an object, including: an imaging unit having an imaging optical system that forms an image of an object, and an imaging device that captures the image of the object formed by the imaging optical system; a stain method estimation unit that estimates a stain method of the object by analyzing image data of the object as obtained from the imaging unit; and a data reduction processing unit that reduces data volume of image data of the object through lowering of the resolution of the image data, if the stain method estimated by the stain method estimation unit is a predetermined stain method.

The present invention in its second aspect provides an imaging system that acquires image data through imaging of an object, including: an imaging unit having an imaging optical system that forms an image of an object, and an imaging device that captures the image of the object formed by the imaging optical system; a stain method estimation unit that estimates a stain method of the object by analyzing image data of the object as obtained from the imaging unit; and a data reduction processing unit that reduces data volume of image data of the object if the stain method estimated by the stain method estimation unit is a predetermined stain method, wherein the data reduction processing unit includes a compression unit that compresses image data obtained from the imaging unit.

The present invention in its third aspect provides an imaging system that acquires image data through imaging of an object, including: an imaging unit having an imaging optical system that forms an image of an object, and an imaging device that captures the image of the object formed by the imaging optical system; a stain method estimation unit that estimates a stain method of the object by analyzing image data of the object as obtained from the imaging unit; and a data reduction processing unit that reduces data volume of image data of the object if the stain method estimated by the stain method estimation unit is a predetermined stain method, wherein the imaging unit has a first imaging unit and a second imaging unit that performs imaging at a higher definition than the first imaging unit, the stain method estimation unit estimates a stain method using image data obtained from the first imaging unit, and the data reduction processing unit reduces data volume of image data obtained from the second imaging unit.

The present invention in its fourth aspect provides an image processing apparatus that processes image data of an object, including: an image acquisition unit that acquires image data of an object; a stain method estimation unit that estimates a stain method of the object by analyzing image data of the object as acquired by the image acquisition unit; and a data reduction processing unit that reduces data volume of image data of the object through lowering of the resolution of the image data, if the stain method estimated by the stain method estimation unit is a predetermined stain method.

The present invention in its fifth aspect provides an image processing apparatus that processes image data of an object, including: an image acquisition unit that acquires image data of an object; a stain method estimation unit that estimates a stain method of the object by analyzing image data of the object as acquired by the image acquisition unit; and a data reduction processing unit that reduces data volume of image data of the object if the stain method estimated by the stain method estimation unit is a predetermined stain method, wherein the stain method estimation unit estimates a stain method using data of a reduced image of the image data acquired by the image acquisition unit.

The present invention in its sixth aspect provides an image processing apparatus that processes image data of an object, including: an image acquisition unit that acquires image data of an object; a stain method estimation unit that estimates a stain method of the object by analyzing image data of the object as acquired by the image acquisition unit; and a data reduction processing unit that reduces data volume of image data of the object if the stain method estimated by the stain method estimation unit is a predetermined stain method, wherein the data reduction processing unit includes a compression unit that compresses image data acquired by the image acquisition unit.

The present invention in its seventh aspect provides an image processing apparatus that processes image data of an object, including: an image acquisition unit that acquires image data of an object; a stain method estimation unit that estimates a stain method of the object by analyzing image data of the object as acquired by the image acquisition unit; and a data reduction processing unit that reduces data volume of image data of the object if the stain method estimated by the stain method estimation unit is a predetermined stain method, wherein the data reduction processing unit decides a reduction method of data volume in accordance with a file format of image data acquired by the image acquisition unit.

The present invention in its eighth aspect provides a computer program stored on a non-transitory computer readable medium, the program causing a computer to perform a method including the steps of: acquiring image data of an object; estimating a stain method of the object by analyzing the acquired image data of the object; and reducing data volume of image data of the object through lowering of the resolution of the image data, if the estimated stain method is a predetermined stain method.

The present invention in its ninth aspect provides a computer program stored on a non-transitory computer readable medium, the program causing a computer to perform a method including the steps of: acquiring image data of an object; estimating a stain method of the object by analyzing the acquired image data of the object; and reducing data volume of image data of the object if the estimated stain method is a predetermined stain method, wherein in the estimation step, the stain method is estimated using data of a reduced image of the image data.

The present invention in its tenth aspect provides a computer program stored on a non-transitory computer readable medium, the program causing a computer to perform a method including the steps of: acquiring image data of an object; estimating a stain method of the object by analyzing the acquired image data of the object; and reducing data volume of image data of the object if the estimated stain method is a predetermined stain method, wherein the reduction step includes a step of compressing the image data.

The present invention in its eleventh aspect provides a computer program stored on a non-transitory computer readable medium, the program causing a computer to perform a method including the steps of: acquiring image data of an object; estimating a stain method of the object by analyzing the acquired image data of the object; and reducing data volume of image data of the object if the estimated stain method is a predetermined stain method, wherein in the reduction step, a reduction method of data volume is decided in accordance with a file format of the image data.

The present invention succeeds in enhancing throughput upon batch processing of image data of multiple objects.

Further features of the present invention will become apparent from the following description of exemplary embodiments with reference to the attached drawings.

### BRIEF DESCRIPTION OF THE DRAWINGS

FIG. 1 is a configuration diagram of a virtual slide system;

FIG. 2 is a configuration diagram of a main measurement unit and a preliminary measurement unit;

FIG. 3 is an internal configuration diagram of an image processing apparatus;

FIG. 4 is a flowchart of main measurement processing and preliminary measurement estimation control processing in a first embodiment;

FIG. 5 is a set of diagrams illustrating imaging regions in a main measurement and a preliminary measurement;

FIG. 6 is a set of diagrams for explaining movement directions of an XY stage and a Z stage;

FIG. 7 is a flowchart of preliminary measurement data acquisition processing and stain method estimation processing in the first embodiment;

FIG. 8 is a set of diagrams illustrating a color histogram used for stain method estimation in the first embodiment;

FIG. 9 is a set of diagrams illustrating a stain method estimation method in the first embodiment;

FIG. 10 is a flowchart of imaging condition setting processing in the first embodiment;

FIG. 11 is a set of diagrams for explaining a binning process in a CCD image sensor in the first embodiment;

FIG. 12 is a diagram for explaining a binning process in a CMOS image sensor in a second embodiment;

FIG. 13 is a block diagram of a coding and decoding device in a JPEG compression/coding scheme in a third embodiment;

FIG. 14 is a flowchart of imaging condition setting processing in a fourth embodiment;

FIG. 15 is a diagram illustrating the configuration of an imaging optical system of a main measurement unit in the fourth embodiment; and

FIG. 16 is a flowchart illustrating a processing sequence in stain estimation control processing in a fifth embodiment.

### DESCRIPTION OF THE EMBODIMENTS

### First Embodiment

### Overall System Configuration

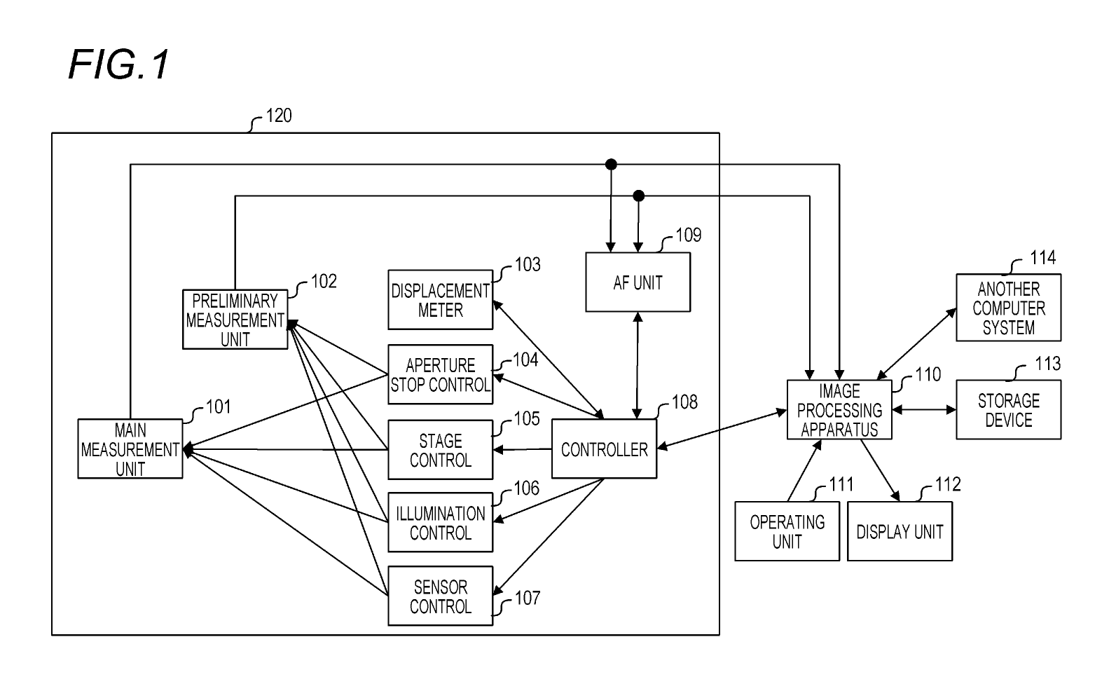

FIG. 1 illustrates a virtual slide system in an embodiment of an imaging system of the present invention.

The virtual slide system is made up of an imaging device (also referred to as virtual slide scanner) 120 that acquires image data of an object, an image processing apparatus (also referred to as host computer) 110 that performs data processing and control on the image data, and peripheral devices of the image processing apparatus 110.

The image processing apparatus 110 is connected to an operating unit 111 that receives inputs from a user via an operating device such as a keyboard or a mouse, and a display unit 112 that displays a processed image. A storage device 113 and another computer system 114 are connected to the image processing apparatus 110.

In a case where multiple objects (slides) are imaged, the imaging device 120 captures images of the each object sequentially, under the control of the image processing apparatus 110, and the image processing apparatus 110 performs required processing on image data of each object. The obtained image data of each object is transmitted to, and stored in, the storage device 113, which is a storage unit for large amounts of data, or the other computer system 114.

Imaging (preliminary measurement and main measurement) in the imaging device 120 is accomplished through reception of user input, issuing of an instruction by the image processing apparatus 110 to a controller 108, and subsequent control of a main measurement unit 101 and a preliminary measurement unit 102 by the controller 108.

The main measurement unit 101 is an imaging unit that acquires a high-definition image for object diagnosis in the slide. The preliminary measurement unit 102 is an imaging unit that performs imaging prior to a main measurement. The preliminary measurement unit 102 acquires images for the purpose of imaging control information acquisition, in order to acquire images with good precision. As explained in more detail further on, the characterizing processing of the present embodiment involves controlling the main measurement unit 101, which is a second imaging unit, using data from imaging by the preliminary measurement unit 102, which is a first imaging unit, so that data volume is reduced as a result in accordance with the object.

The controller 108 is connected to a displacement meter 103 so that a position and distance of a slide placed on the stage within the main measurement unit 101 or preliminary measurement unit 102 can be measured. The displacement meter 103 is used to measure the thickness of a sample on the slide when performing the main measurement and the preliminary measurement.

The controller 108 is also connected to an aperture stop control 104, a stage control 105, an illumination control 106, and a sensor control 107 for controlling imaging conditions of the main measurement unit 101 and the preliminary measurement unit 102. These controls are designed to respectively control the aperture stop, the stage, illumination, and operation of the image sensor according to a control signal from the controller 108.

The stage includes an X-Y stage for moving the slide in a direction perpendicular to the optical axis, and a Z stage for moving the slide in a direction along the optical axis. The X-Y stage is used to capture images of a sample spreading in a direction perpendicular to the optical axis, and the Z stage is used to capture images with different focal positions changed in the depth direction. Although not shown, the imaging device 120 is provided with a rack in which a plurality of slides can be stowed, and a transport mechanism for feeding a slide from the rack to the imaging position above the stage. In case of batch processing, the controller 108 controls the transport mechanism so that the slides are fed one by one from the rack to the stage of the preliminary measurement unit 102 and then to the stage of the main measurement unit 101.

An AF unit 109 for realizing autofocus using captured images is connected to the main measurement unit 101 and the preliminary measurement unit 102. The AF unit 109 is capable of finding a focusing position through control of the position of the stages of the main measurement unit 101 and the preliminary measurement unit 102, by way of the controller 108. The autofocus scheme is of passive type, relying on images. The autofocus scheme that is used is a known phase contrast scheme or contrast detection scheme.

(Main Measurement Unit)

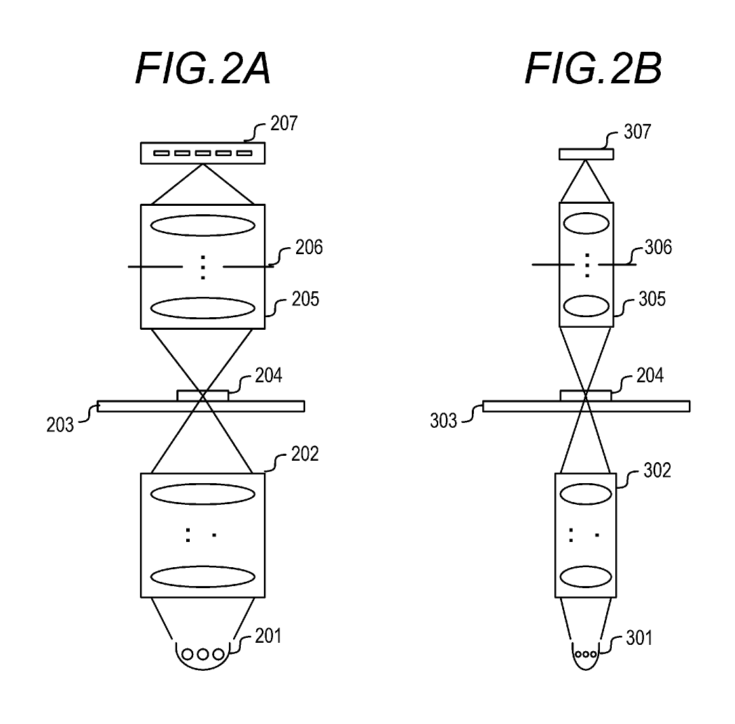

FIG. 2A is a diagram illustrating an internal configuration of the main measurement unit 101 according to the first embodiment.

Light from a light source 201 is passed through an illumination optical system 202 to be uniform and without variation in luminous energy, and applied to a slide 204 placed on a stage 203. The slide 204 is prepared by applying a slice of tissue or smear cell to be observed on a slide glass and fixing the same under a cover glass together with an encapsulant such that the object is in an observable state.

An imaging optical system 205 is for magnifying an image of an object and guiding the same to an imaging device 207 serving as imaging means. The light passing through the slide 204 forms an image on the imaging surface of the imaging device 207 through the imaging optical system 205. The imaging optical system 205 includes an aperture stop 206. The depth of field can be controlled by adjusting the aperture stop 206.

The image of the object formed on the imaging surface is opto-electric converted by the imaging device 207 composed of a plurality of image sensors, and then A/D converted. The image is then sent to the image processing apparatus 110 as an electric signal. The description of the present embodiment will be made on the assumption that image development processing to be performed after the A/D conversion, including, representatively, noise removal, color conversion processing, and sharpness enhancing processing is performed in the inside of the image processing apparatus 110. However, the image development processing may be performed by a dedicated image processing unit (not shown) connected to the imaging device 207, and then data may be transmitted to the image processing apparatus 110. Such an embodiment is also covered by this invention.

(Preliminary Measurement Unit)

FIG. 2B is a diagram illustrating an internal configuration of the preliminary measurement unit 102 according to the first embodiment.

Light from a light source 301 is passed through an illumination optical system 302 to be uniform and without variation in luminous energy, and applied to a slide 204 placed on a stage 303. The light passing through the slide 204 forms an image on the imaging surface of an imaging device 307 by means of an imaging optical system 305. The imaging optical system 305 includes an aperture stop 306, so that the depth of field can be controlled by adjusting the aperture stop 306.

The image of the object formed on the imaging surface is opto-electric converted by the imaging device 307 having an image sensor, and then A/D converted. The image is then sent to the image processing apparatus 110 as an electric signal. The description of the present embodiment will be made on the assumption that image development processing to be performed after the A/D conversion, including, representatively, noise removal, color conversion processing, and sharpness enhancing processing is performed in the inside of the image processing apparatus 110. However, the image development processing may be performed by a dedicated image processing unit (not shown) connected to the imaging device 307, and then data may be transmitted to the image processing apparatus 110. Such an embodiment is also covered by this invention.

(Image Processing Apparatus)

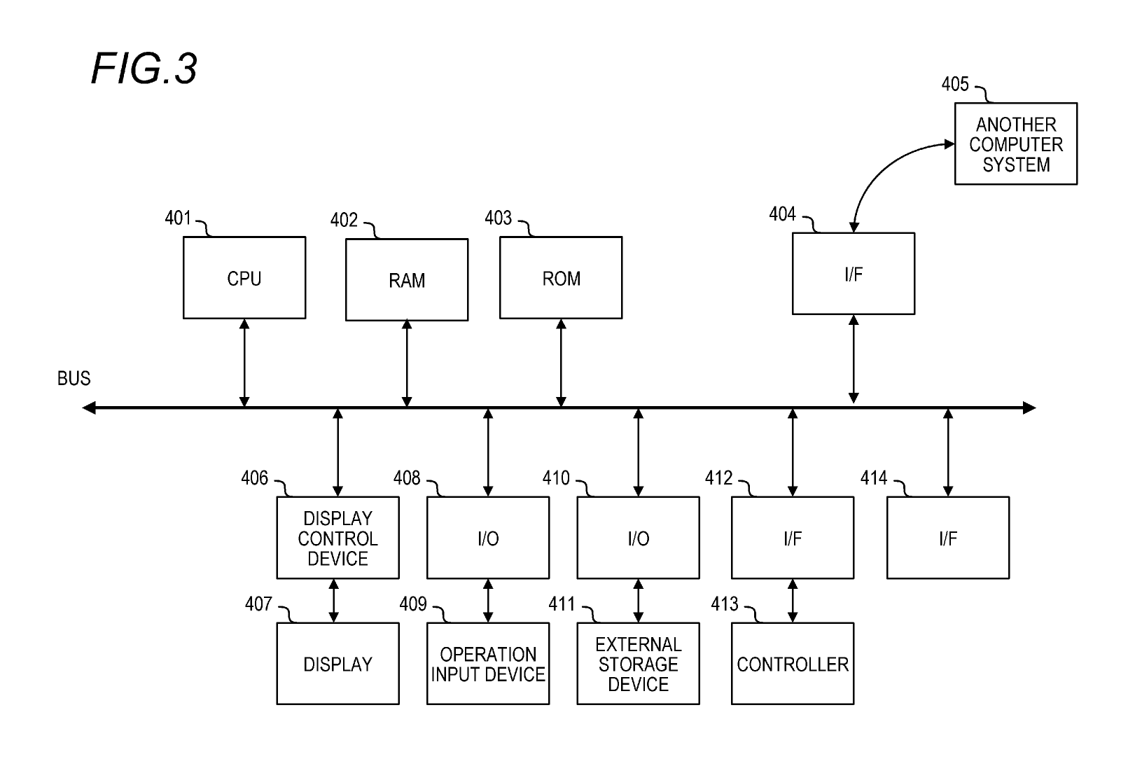

FIG. 3 is a diagram illustrating an internal configuration of the image processing apparatus (host computer) 110 according to this invention.

A CPU 401 controls the entire of the image processing apparatus by using a program or data stored in a RAM 402 or ROM 403. The CPU 401 also performs various types of arithmetic processing and data processing to be described in the following description of the embodiment, for example, stain method estimation processing and imaging condition setting processing.

The RAM 402 has an area for temporarily storing a program and data loaded from an external storage device 411, as well as a program and data downloaded from another computer system 405 via an I/F (interface) 404. The RAM 402 has a work area for the CPU 401 to perform various types of processing. The ROM 403 stores a computer function program, setting data and so on. A display control device 406 performs control processing to cause a display 407 to display images and characters. The display 407 displays a screen to prompt the user to input, and also displays an image of the image data acquired from the virtual slide scanner 120 and processed by the CPU 401.

An operation input device 409 is formed of a device such as a key board or a mouse which is capable of inputting various instructions to the CPU 401. The user inputs information for controlling operation of the virtual slide scanner 120 through the operation input device 409. The reference numeral 408 indicates an I/O for notifying the CPU 401 of various instructions or the like which are input through the operation input device 409.

The external storage device 411 is a mass information storage device like a hard disc, which stores an OS (operating system), a program for causing the CPU 401 to perform processing to be described in the following description of the embodiment, and image data obtained by scanning by batch processing.

Writing of information into the external storage device 411 and retrieval of information from the external storage device 411 are performed by way of the I/O 410. The controller 413 is a unit for controlling the virtual slide scanner 120, and exchanges a control signal and response signal with the CPU 401 via an I/F (interface) 412.

The controller 413 has a function to control the main measurement unit 101 and the preliminary measurement unit 102. An I/F (interface) 414 is connected to an interface other than those described above, for example an external interface for importing data output from a CMOS image sensor or a CCD image sensor. The interface used herein may be a serial interface such as a USB or IEEE1394, or a camera link interface. Various peripheral devices can be connected to the host computer via this I/F 414.

(Main Measurement Processing)

The virtual slide system of the present embodiment performs a “preliminary measurement” for estimating a stain method of the object (specimen), and a “main measurement” of imaging the object at a resolution according to the estimated stain method. Herein, the processing of estimating a stain method by analyzing low-resolution image data obtained in a preliminary measurement, and, on the basis of the results, controlling the operation of the main measurement unit 101, is referred to as “preliminary measurement estimation control processing”. An explanation follows next, in the reverse order of the actual processing, of the gist of main measurement processing in the first place, followed by a detailed explanation of the preliminary measurement estimation control processing, which is a characterizing feature of the present embodiment.

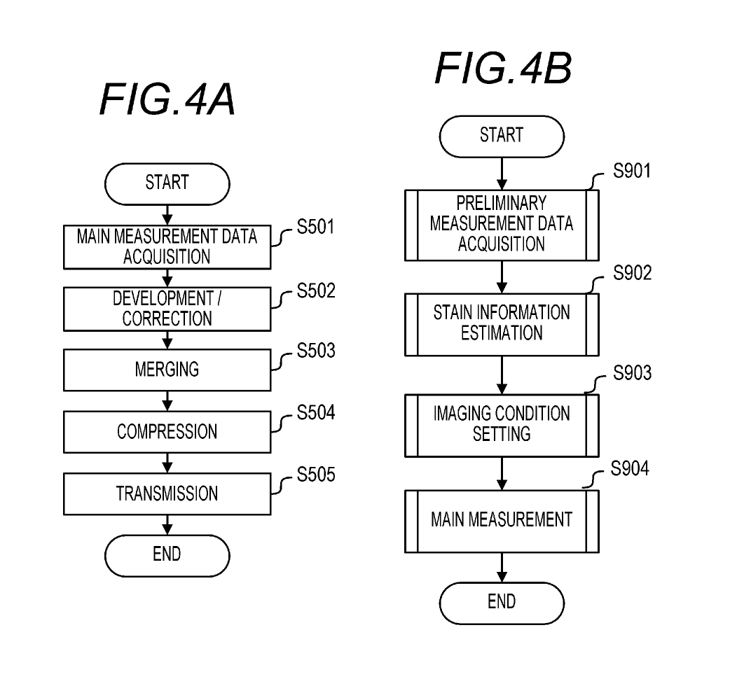

FIG. 4A is a diagram illustrating a flow of the main measurement processing.

In main measurement data acquisition processing S501, the main measurement unit 101 captures an image of the slide under the control of the controller 108 and transmits the image data to the image processing apparatus 110.

Subsequently, in development/correction processing S502, the image processing apparatus 110 performs, on the image data, various types of processing including color conversion processing, sharpness enhancing processing, and noise reduction processing, whereby colors of the monitor-displayed image can be approximated to the real colors of the sample, and the noise in the image can be reduced.

In merging processing S503, the image processing apparatus 110 joins image sections captured by dividing the object surface to form an image of a target region (for example, a region of 20×20 mm) on the slide.

Next, in compression processing S504, the image processing apparatus 110 compresses the merged data to reduce the data volume. The compression method applicable here includes a still image compression/coding method such as JPEG or JPEG2000. Subsequently, in transmission processing S505, the image processing apparatus 110 transmits the image data to the storage device 113 to store the same in the storage device 113. Alternatively, the image processing apparatus 110 may transmit the image data to a computer system 114 or an image server on the network through a network I/F.

(Main Measurement Processing: Main Measurement Data Acquisition Processing S501)

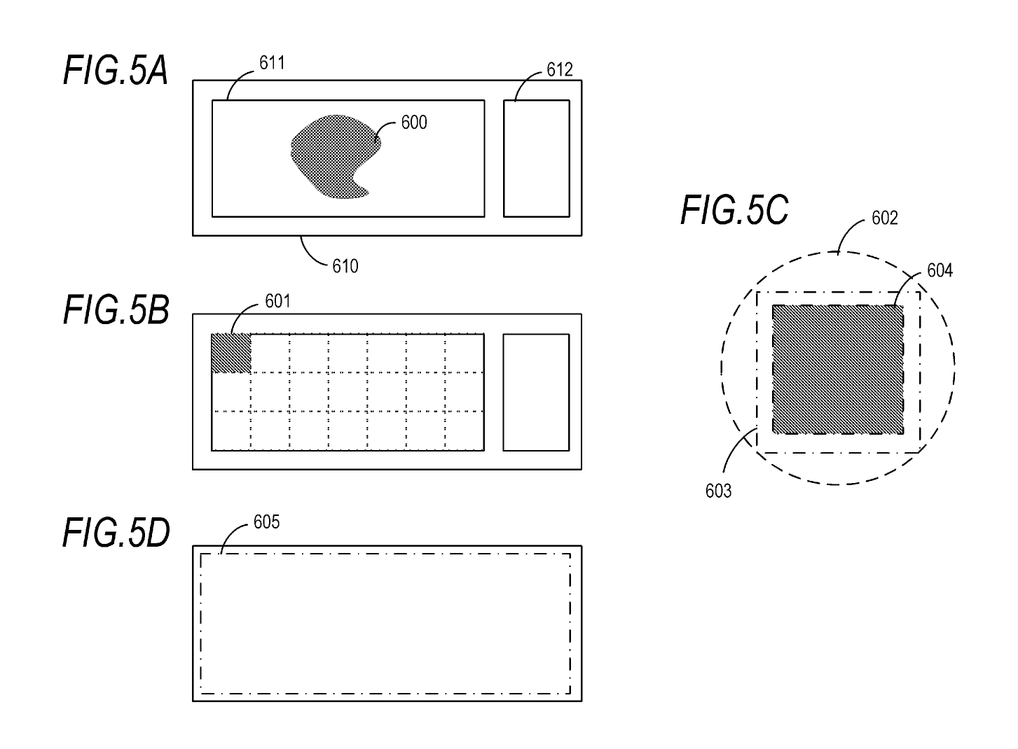

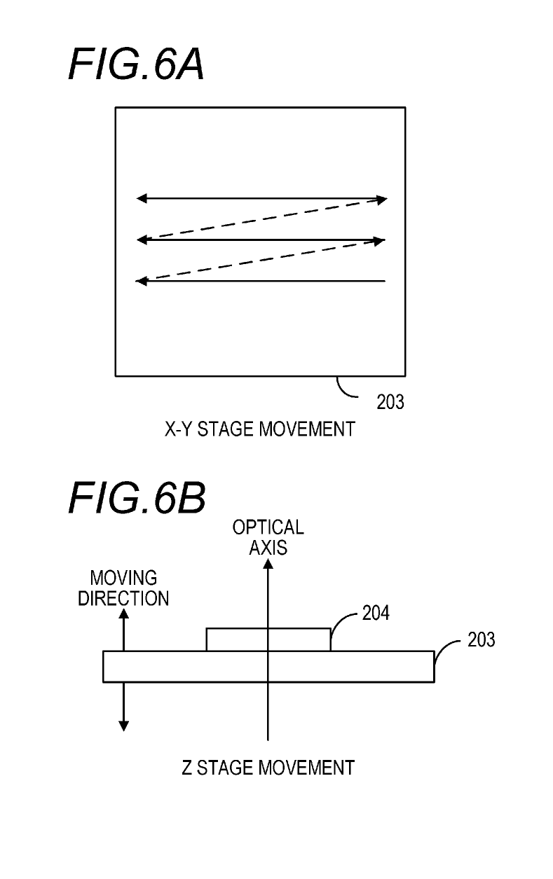

The main measurement data acquisition processing S501 will be described with reference to FIGS. 5 and 6.

FIG. 5A is a schematic diagram of a slide. There are, on a slide glass 610, an area where a sample 600 is enclosed under a cover glass 611 and a label area 612. In the main measurement data acquisition processing S501 according to the present embodiment, the region where it is assumed that the cover glass 611 exists is the region to be imaged. It is preferable to reduce the data volume by finding a circumscribing rectangular region where the sample 600 exists in the preliminary measurement, and imaging only that region in the main measurement.

FIG. 5B illustrates how the region where the cover glass 611 exists is segmented into a plurality of sections and imaged in the main measurement data acquisition processing S501. FIG. 5C shows the imaging surface. An effective field of view 602 indicates an area in which the image can be viewed through the imaging optical system 205 of the main measurement unit 101, a sensor effective region 603 indicates an area in which the image can be captured by the image sensor of the imaging device 207.

An imaging region 601 (shaded area) in the object surface, whose image is formed through the imaging optical system 205 of the main measurement unit 101, corresponds to the imaging region 604 in the imaging surface.

As shown in FIG. 5C, a slightly broader area is assigned to the sensor effective region 603 than the imaging region 604. This is a margin to allow optical aberration of the imaging optical system 205 and deviation of position where the image sensor is attached. This means that, even if there is optical aberration or deviation of the position where the sensor is attached, the imaging region 601 on the object surface is contained within the sensor effective region 603. In the merging processing S503, correction of aberration or positional deviation is performed on the image of the sensor effective region 603, and a portion corresponding to the imaging region 604 is extracted from the corrected image to be used for merging of the images.

FIG. 6A illustrates directions and sequence in which the stage 203 is moved in the XY direction when the segmented area shown in FIG. 5B is imaged in a raster scan sequence. In order to image a lower-right section of the slide from the left side above the slide, the stage 203 on which the slide is mounted is moved in the opposite direction, that is, from the lower right to the upper left.

Thus, a wide area can be imaged with a relatively small-sized image sensor by segmenting the imaging region into a plurality of sections and imaging these sections while moving the stage 203.

FIG. 6B shows direction in which the stage 203 is moved in the Z direction (depth direction) when a plurality of images are captured with different focal positions (depths of observation, or focusing positions) in the main measurement data acquisition processing S501. As shown in FIG. 6B, in order to shift the focal position to the upper side of the sample in the slide 204 (to the rear side of the cover glass), the stage 203 is moved downward in the Z direction along the optical axis of the imaging optical system 205. In contrast, in order to shift the focal position to the lower side of the sample (to the top side of the slide glass), the stage 203 is moved upward in the Z direction. This processing of acquiring image data of a plurality of images with different focal positions by imaging the sample for a plurality of times while changing the focal position is generally referred to as “Z-stacking”.

The focal position can be changed by moving the imaging device 207, or both of the imaging device 207 and the stage 203 along the optical axis of the imaging optical system 205. Further, the focal position can be changed by controlling the lens of the imaging optical system 205 to optically change the focal distance. Since the stage mechanism of the preliminary measurement unit 102 is substantially the same as that of the main measurement unit 101, description thereof will be omitted.

(Preliminary Measurement Estimation Control Processing)

FIG. 4B is a diagram illustrating a processing flow of the preliminary measurement estimation control processing.

In preliminary measurement data acquisition processing S901, the preliminary measurement unit 102 performs imaging of a slide under the control of the controller 108, and transmits image data to the image processing apparatus 110.

Next, in stain method estimation processing S902, the image processing apparatus 110 analyzes the image captured by the imaging unit 307, and estimates the stain method that has been applied to an object (specimen).

Next, in imaging condition setting processing S903, the image processing apparatus 110 sets an imaging condition, for the main measurement processing S904, to the main measurement unit 101, on the basis of the information estimated in the stain method estimation processing S902.

Lastly, in main measurement processing S904, focusing is performed at a desired position in the object, which is sandwiched between a slide glass and a cover glass, by utilizing the imaging condition set in the imaging condition setting processing S903, and the main measurement unit 101 performs image acquisition. A high-resolution merged image is generated as a result of the processing explained in FIG. 4A.

FIG. 5D shows an imaging region 605 of the slide 204 in the preliminary measurement. The preliminary measurement has a purpose of acquiring imaging control information for imaging the main measurement with high precision. What is required for the preliminary measurement is to obtain rough understanding of features of the image, and the magnification need not be as high as that in the main measurement. The depth of field should be large in the preliminary measurement, which makes it easy to focus on the sample.

In the preliminary measurement of the present embodiment, the entire of the slide 204 is imaged at a low magnification. Unlike the main measurement, the entire of the slide 204 is collectively imaged with a single image sensor without being segmented into a plurality of sections. This makes it possible to simplify the configuration of the preliminary measurement unit 102, and to reduce the time required for the preliminary measurement and hence the time required the imaging processing as a whole, including the preliminary measurement and the main measurement. However, if a resolution as high as that of the main measurement is required in the preliminary measurement, the magnification may be increased to the same level as in the main measurement, and the imaging may be performed while segmenting the region to be imaged on the surface of the object into a plurality of sections.

(Preliminary Measurement Estimation Control Processing: Preliminary Measurement Data Acquisition Processing S901)

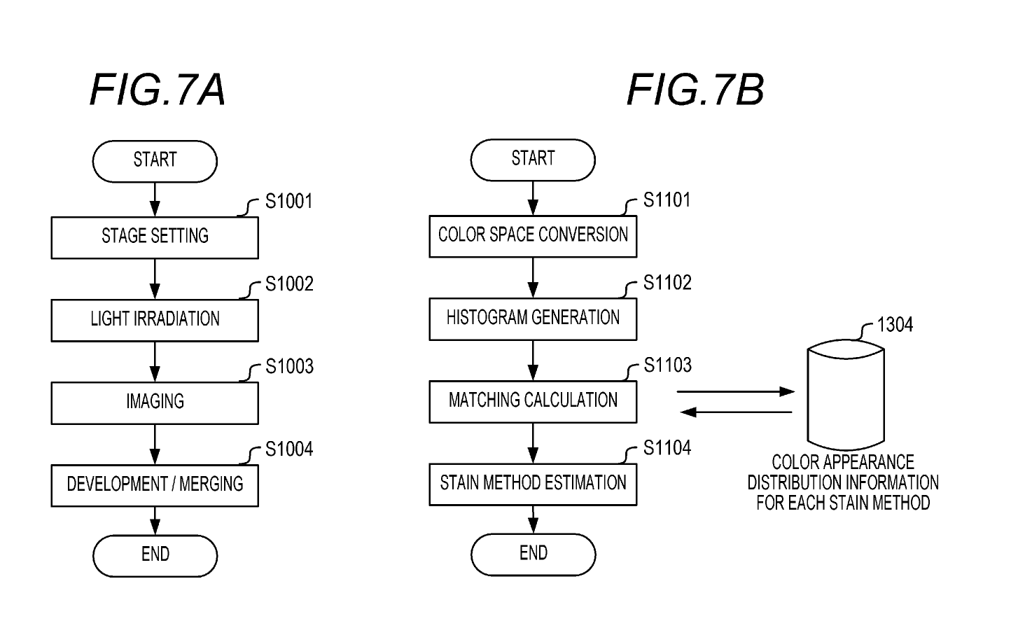

FIG. 7A illustrates details of the preliminary measurement data acquisition processing S901 according to the present embodiment.

In stage setting processing S1001, the controller 108 controls the transport mechanism to set the slide 204 on the stage 303 of the preliminary measurement unit 102.

In light irradiation processing S1002, the light source 301 is turned on to irradiate the slide 204 with light. In an imaging processing S1003, the light is focused on the imaging surface after passing through the illumination optical system 302, the slide 204, and the imaging optical system 305, and formed into an image by the image sensor of the imaging device 307. According to the present embodiment, the image is exposed sequentially to three different light sources 301, namely RGB light sources, and images are captured three times, whereby a color image is obtained. This means that the processing steps of S1002 and S1003 are repeated three times.

In development/merging processing S1004, the image processing apparatus 110 performs development/merging processing on raw data obtained in the imaging processing S1003. In the development/merging processing S1004, color conversion, noise removal processing and other processing are performed. There are various color space standards such as sRGB and Adobe RGB. While any of them may be used, the colors are converted into a sRGB color space which is representative of them in the present embodiment.

(Preliminary Measurement Estimation Control Processing: Stain Method Estimation Processing S902)

FIG. 7B illustrates details of stain method estimation processing S902 which constitutes a feature characteristic of the present embodiment. The stain method estimation processing according to the present embodiment is processing for estimating a method of staining the sample based on the colors of the image data obtained in the preliminary measurement.

Firstly, in color space conversion processing S1101, a color space conversion is performed on the image data obtained in the preliminary measurement. The color space includes, xyY colorimetric system (xy chromaticiy diagram), luminance/chrominance signal YUV, uniform color space CIE L*a*b*, HSV color space, HLS color space, and so on. In the present embodiment, the image data is converted into the CIE L*a*b* color space. If the subsequent processing is to be performed while the image data remains in sRGB, the processing step of S1101 may be omitted.

In histogram generation processing S1102, the image processing apparatus 110 generates a color histogram (color appearance distribution information) from the image data which has been subjected to the color space conversion.

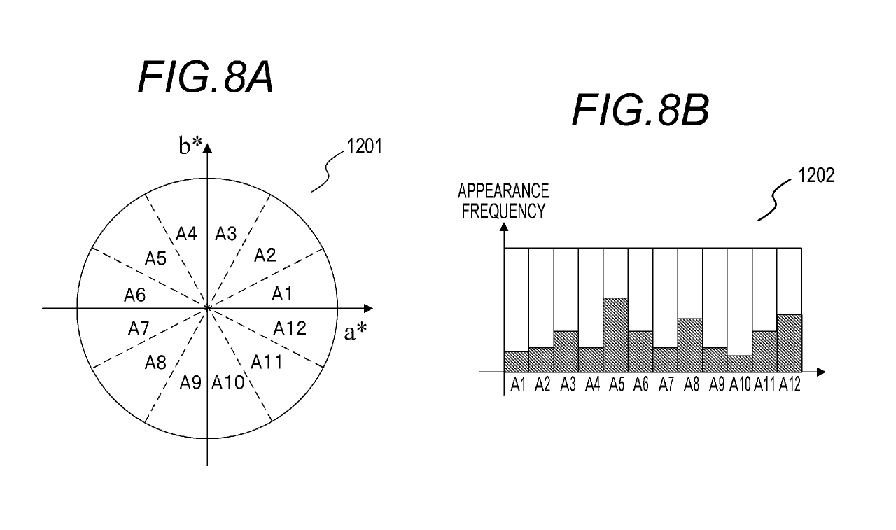

FIGS. 8A and 8B illustrate an example of the histogram generation processing S1102. As shown in FIG. 8A, for example, the L*a*b* color space is segmented equally into 12 sections of 30 degrees each around the L* axis, and numbers of pixels appearing in the respective sections A1 to A12 are counted. As shown in FIG. 8B, a one-dimensional histogram is drawn for the image data obtained in the preliminary measurement. The horizontal axis of FIG. 8B indicates the sections A1 to A12, and the vertical axis indicates the frequency of appearance of pixels (the number of pixels).

As seen from FIGS. 5A and 5D, the preliminary measurement imaging region 605 includes an area where the sample 600 is not present. The area where the sample 600 is not present assumes a color of the illumination, namely an achromatic color. The precision of estimation of the sample staining method can be improved by removing pixels not pertinent to the sample. Therefore, the pixels present at a predetermined distance (pixels of a substantially achromatic color) from the L* axis should be removed from the histogram.

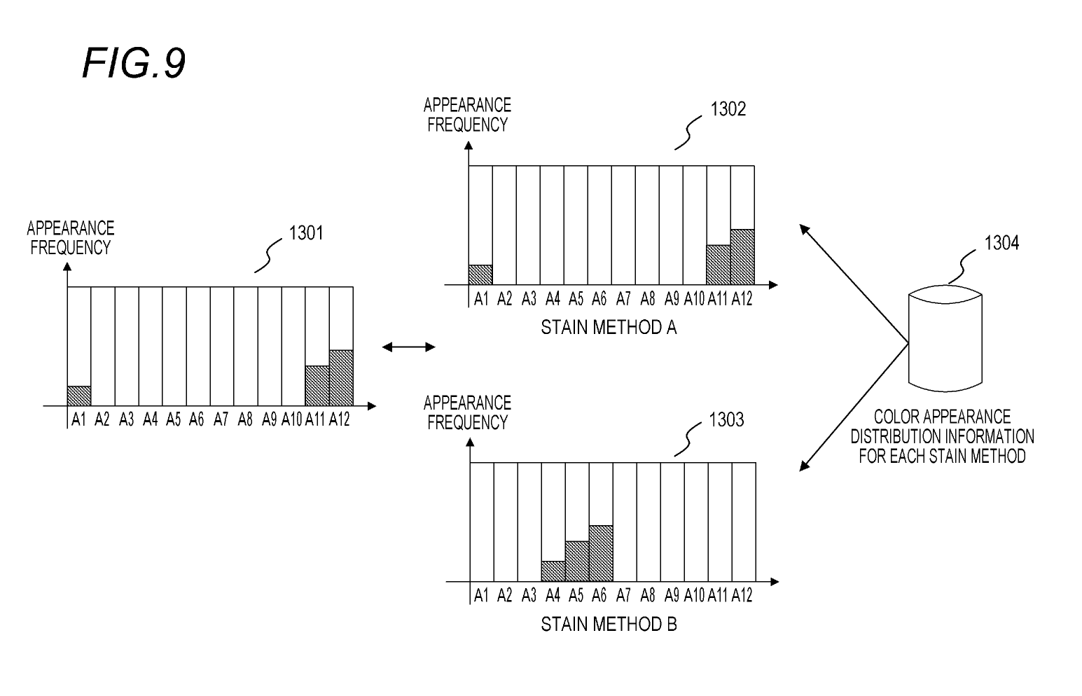

In matching calculation processing S1103, the image processing apparatus 110 acquires, from a data base 1304, a color histogram (color appearance distribution information) for each stain method. There are preliminarily stored in the data base 1304 color histograms prepared using some samples of the respective stain methods and indicating a typical color appearance distribution of each of the stain methods. In FIG. 9, the reference numeral 1302 indicates a color histogram of a stain method A, 1303 indicates a color histogram of a stain method B. The image processing apparatus 110 compares the histogram 1301 calculated in the histogram generation processing S1102 with the typical histograms 1302 and 1303 of the respective stain methods and calculates a matching for each of the stain methods.

A matching (similarity) between histograms can be evaluated by taking an inner product between the histograms or a histogram intersection. By using normalized cross-correlation (by normalizing the total sum of one-dimensional histogram to be zero before calculating the inner product), the maximum value of the inner product can be suppressed to one, which facilitates introduction of a threshold for determination in the following step, and makes it possible to eliminate less accurate estimation.

In stain method estimation processing S1104, a stain method which exhibits the highest matching is selected as the stain method for the sample which has been subjected to the preliminary measurement. For example, in the example shown in FIG. 9, the color histogram 1301 of the sample which has been subjected to the preliminary measurement assumes the greatest inner product (correlation) with the color histogram 1302 of the stain method A.

In the stain method estimation processing S1104, it can be determined that “the stain method is unknown” when the maximum matching is smaller than the predetermined threshold. If a stain method which is not the one for the sample is erroneously selected, the setting of appropriate imaging conditions likely becomes impossible. Therefore, it is desirable to introduce a threshold in order to reduce the probability of erroneous determination.

Information on the stain method determined in the stain method estimation processing S1104 is stored in an appropriate location such as the RAM 402 or the external storage device 411 accessible by the image processing apparatus 110. A data base 1304 for storing the color histogram for each of the stain methods may be located either within the external storage device 411 or within another computer system 405.

(Preliminary Measurement Estimation Control Processing: Imaging Condition Setting Processing S903)

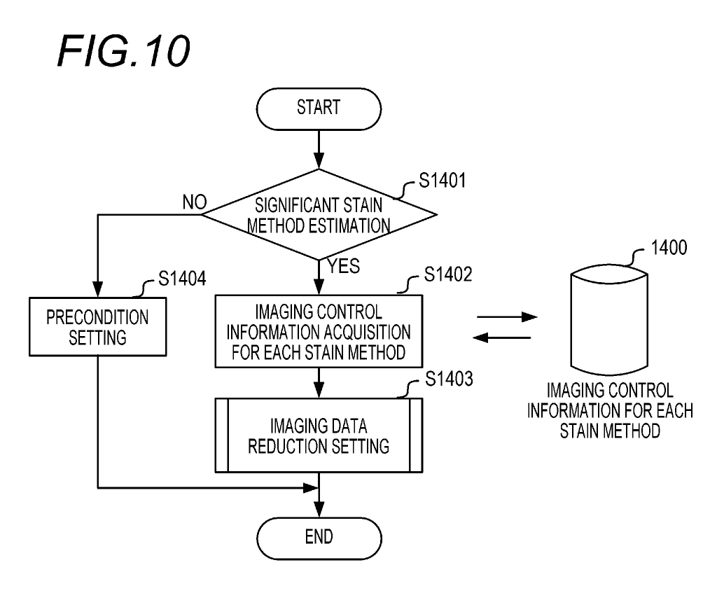

FIG. 10 illustrates the details of the imaging condition setting processing S903.

Firstly, in S1401, the image processing apparatus 110 determines whether significant stain estimation has been performed or not. If highly accurate estimation has been performed successfully, the processing proceeds to step S1402, and the image processing apparatus 110 accesses a database 1400 and acquires imaging control information of each stored stain method. In S1403, the image processing apparatus 110 sets an imaging condition that allows reducing imaging data volume in the main measurement, on the basis of the imaging control information acquired in S1402. In the present embodiment, imaging data reduction setting processing S1403 is processing of changing (modifying) the charge reading method in the imaging unit 207. The details thereof are explained further on.

If in S1401 it is determined that no significant stain estimation could be made (i.e. the stain method is unknown), the image processing apparatus 110 performs, in S1404, processing of setting a precondition established beforehand. In the present embodiment, the precondition setting is “perform no data reduction”, in order to prevent important information from being overlooked. However, if a default compression parameter is set in the compression processing of step S504 in FIG. 4A, then image data is compressed using that compression parameter.

(Imaging Data Volume Reduction)

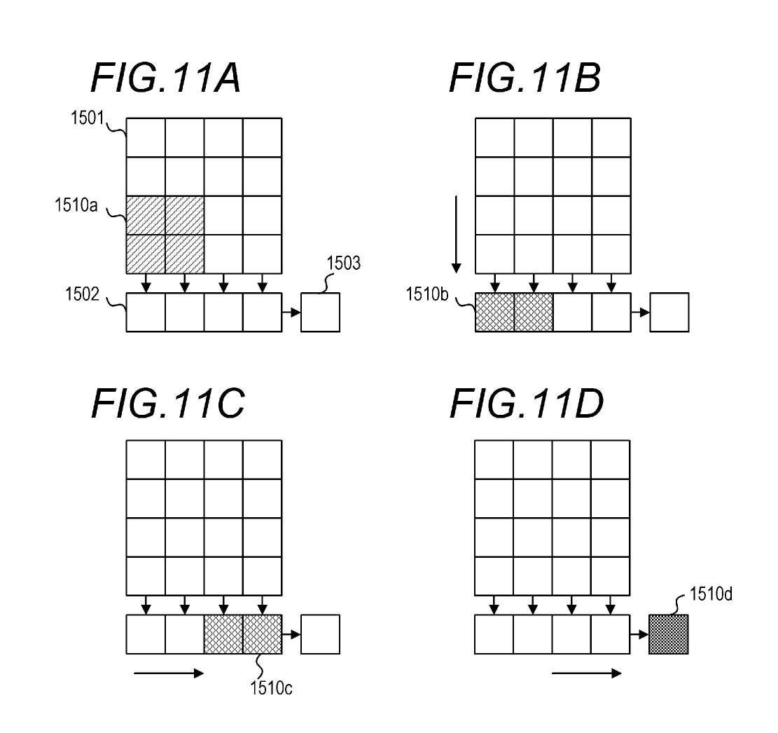

FIG. 11 is a diagram illustrating schematically the way in which a pixel signal is read from a photo acceptance unit of the CCD image sensor. The pixel signal reading method in the CCD image sensor will be explained first with reference to FIG. 11.

The reference numeral 1501 denotes a one-pixel photo acceptance unit in the CCD image sensor. To read the charge stored in each pixel 1501 through photoelectric conversion, firstly the charge of each column is transferred, in the vertical direction, according to a bucket brigade scheme, and moves onto a horizontal register. Next, charge held in the horizontal register 1502 moves pixel by pixel in the horizontal direction. As a result of this operation, the charge stored in each pixel can be read out sequentially at an output node 1503.

The pixels of the horizontal register 1502 and the output node 1503 constitute a pixel, referred to as superpixel, that encompasses a number of accumulated electrons (well depth) large enough to enable aggregation and accumulation of the charge stored in a plurality of photo acceptance units.

A binning process in the CCD image sensor is explained next. The binning process is a process of aggregating the outputs (charge) of photo acceptance units of a plurality of pixels in the image sensor, and outputting the aggregated outputs as a signal of one pixel. Performing such a binning process allows obtaining a low-noise, gradation-rich image, but of lower resolution. In the present description, the number of vertical and horizontal pixels of the photo acceptance units aggregated in one final pixel will be expressed as the “binning setting”.

FIGS. 11A to 11D illustrate the flow of extracting a signal value from photo acceptance units of a CCD image sensor in a 2×2 binning process.

As illustrated in FIG. 11A, light strikes the portion denoted by the reference numeral 1510a in the image sensor, whereupon ‘a’ electrons accumulate in each of the four pixels. As illustrated in FIG. 11B, firstly the charge of two columns moves towards the horizontal register 1502, as a result of which 2×a electrons accumulate in respective two pixels 1510b at the left of the horizontal register 1502. The reference numeral 1510c in FIG. 11C denotes a state upon shifting of the charge in the horizontal register 1502 by two pixels to the right. Further shifting of the charge in the horizontal register 1502 by two pixels to the right, results in 4×a electrons ending up gathered in the output node 1503, as indicated by the reference numeral 1510d in FIG. 11D. As a result, the total value of charge accumulated in four pixels can be read as information of one pixel. In the binning process, the charges of a plurality of pixels are added up, and random noise is reduced thereby, so that the SN ratio is enhanced as a result. Also, an image signal can be obtained that has excellent gradation of an image.

In the example illustrated in FIG. 11, the binning setting is 2×2, but the setting may be an arbitrary number of aggregated vertical and horizontal pixels, for instance 3×3, 4×4, 2×4 or the like.

(Imaging Control Information Acquisition Processing for Each Stain Method S1402)

The details of the imaging control information acquisition processing for each stain method S1402 in FIG. 10 are explained next.

The imaging control information for each stain method in the present embodiment is the binning setting upon readout of a pixel signal from the photo acceptance units of the CCD image sensor. This feature is a characterizing feature of the present embodiment.

In pathological diagnosis, the way in which specimens are prepared differs between histological diagnosis and cytological diagnosis. Stained sites and colors are likewise dissimilar for each stain method. Accordingly, the sites and points that are to be observed vary for each stain method. In histological diagnosis, for instance, an object having a three-dimensional structure is fixed with paraffin, is sliced into thin slices about 4 μm thick, and is stained. The stain method used herein is ordinarily HE staining (hematoxylin and eosin). Histological diagnosis requires comparatively less resolution, since the emphasis is laid on the state of tissues, as cell aggregates, rather than on the characteristics of individual cells. Emphasis is laid, instead, on discriminating between subtle colors and gradations, in order to distinguish between tissues. Accordingly, a binning process is appropriate herein both from the viewpoint of data volume reduction and from the viewpoint of image quality.

In cytological diagnosis, by contrast, cells are collected through excision or fine-needle aspiration, are spread on a slide, are fixed, and are stained. Ordinary stain methods that are used include Papanicolaou staining and Giemsa staining. In cytological diagnosis, unlike in histological diagnosis, the emphasis tends to be laid on information about individual cells, and thus high image resolution is desirable.

In a virtual slide system of sufficient resolving power for diagnosis, in summary, it is found that a binning process in a CCD image sensor is appropriate for a stain method (e.g. HE staining) used for histological diagnosis. On the other hand, a binning process of a CCD image is not that necessary in stain methods (for instance, Papanicolaou staining or Giemsa staining) that are used for cytological diagnosis. (However, a binning process is effective in noise-suppression applications).

The processing of the imaging control information acquisition processing for each stain method S1402 is explained next based on examples.

An example of imaging control information for each stain method, as stored in the database 1400, is described below. In the present embodiment, the data used as imaging control information for each stain method is data in which the stain method and the binning setting are mapped to each other.

TABLE 1

| Stain method | Binning setting |
|---|---|
| HE staining | 2 × 2 |
| Papanicolaou staining | 1 × 1 |
| Giemsa staining | 1 × 1 |

In a case where, for instance, it is estimated that the stain method in S1104 of FIG. 7B is “Papanicolaou staining”, then the binning setting “1×1” is obtained according to the above table in S1402 of FIG. 10. In S1403, next, the image processing apparatus 110 issues to the sensor control 107, by way of the controller 108, an instruction to the effect of setting the binning setting “1×1”. The imaging condition setting processing S903 is over thereby, and the main measurement processing S904 is performed thereupon. The image signal from the CCD image sensor is outputted herein according to the binning setting “1×1”.

In a case where, on the other hand, it is estimated, in S1104, that the stain method is “HE staining”, the binning setting “2×2” is obtained in S1402 according to the table above. In this case, the image signal from the CCD image sensor is outputted, in the main measurement processing S904, according to the binning setting “2×2”. Accordingly, the number of vertical and horizontal pixels in the acquired image is halved with respect to the case of the binning setting “1×1” (i.e. no binning process). The overall size is reduced thus to one fourth. Efficient data volume reduction in accordance with the object can be realized as a result.

In the first embodiment described above, the stain method is estimated in a preliminary measurement and the setting of the binning process is selected according to the estimation; as a result, it becomes possible to reduce the volume of data acquired in the main measurement, also in cases of batch processing of mixed slides having been treated according to a plurality of stain methods. This allows avoiding acquisition of data at an excessive resolution, and allows increasing device throughput. Also, image data is kept down to an appropriate resolution. As a result, this allows enhancing the response speed for display on the display unit 112, for edition in the image processing apparatus 110, and for storage in the storage device 113, so that the user can enjoy a friendlier environment.

In the present embodiment, a table in which the stain method and the binning setting are mapped to each other is used as the imaging control information for each stain method, but the imaging control information is not limited this table example. For instance, a binning setting (aggregated number of respective vertical and horizontal pixels) may be arbitrarily set for each stain method. In the table of the imaging control information there can be set an equivalent magnification, not the binning setting itself. Herein, the equivalent magnification is a value obtained by multiplying the imaging magnifications of an optical system by the reduction ratio of the number of pixels on one side as a result of the binning process. An example of an equivalent magnification table is given below.

TABLE 2

| Stain method | Equivalent magnification |
|---|---|
| HE staining | 20x |
| Papanicolaou staining | 40x |
| Giemsa staining | 40x |

In a case where, for instance, the magnification in the imaging optical system 205 is 40×, and in S1104 it is estimated that the stain method is “HE staining”, the reduction ratio of the number of pixels on one side is 20/40=1/2, which yields a reduction ratio of 2×2. Thus, the same effect as described above can be elicited by performing a binning process for the output of the CCD image sensor in accordance with the reduction ratio obtained on the basis of the equivalent magnification.

A method in which equivalent magnification is used as the imaging control information can be preferably used when the magnification of the imaging optical system 205 is configured to be variable. In a case where, for instance, the imaging magnification is 40× and the equivalent magnification is 20×, the reduction ratio is 2×2. In a case where the imaging magnification is 60× and the equivalent magnification is 20×, the reduction ratio is 3×3. Thus, the reduction ratio can be adaptively decided in accordance with the imaging magnification that is used. This is advantageous in that, as a result, a captured image is obtained that has constant resolution (data volume) at all times, regardless of the actual imaging magnification.

### Second Embodiment

In the second embodiment an example will be explained in which data volume is reduced through a binning process that utilizes a CMOS image sensor. The CMOS image sensor in the present embodiment is of APS (active pixel sensor) type, explained below, that is capable of reading a voltage signal amplified for each pixel.

In the CCD image sensor, charge moves according to a bucket brigade scheme, and is finally amplified collectively. As a result, charges can be aggregated during charge motion. In the case of a CMOS image sensor, however, the charge accumulated in each pixel is read through conversion to voltage and amplification, for each pixel. Accordingly, binning cannot be carried out during charge motion. In the present embodiment, therefore, an operation circuit for performing resolution conversion processing (pixel aggregation processing) is provided after the CMOS image sensor, so that a binning process is realized by performing a data operation on the output signal of the CMOS image sensor.

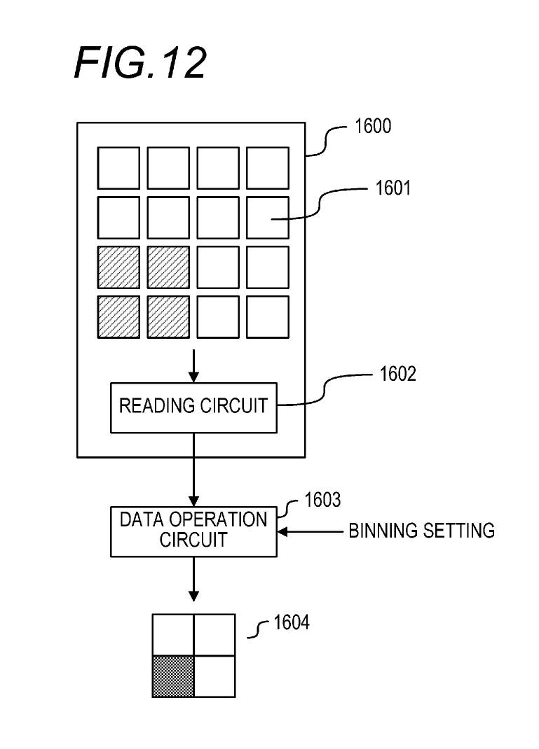

FIG. 12 illustrates an example in which a binning process is realized by using a data operation circuit 1603 that is connected to a CMOS image sensor 1600.

A photo acceptance unit 1601 and a reading circuit 1602 are present in the CMOS image sensor 1600. Each pixel in the photo acceptance unit 1601 is a photo acceptance unit comprising a photodiode. The reading circuit 1602 is connected to each of such photo acceptance units, in such a manner that accumulated charge is read out in the form of voltage.

The reading circuit 1602 has a noise reduction processing circuit by CDS (correlated double sampling) and an A/D conversion circuit. The output of the reading circuit 1602 is a digital signal.

The data operation circuit 1603 carries out a binning process through summation of the digital signals in the aggregated pixels, in accordance with a designated binning setting. The result of the binning process is written in a memory 1604 that is connected to the data operation circuit 1603.

For instance, light is assumed to strike uniformly the CMOS sensor 1600 of FIG. 12. This causes a voltage value d1 (V) to be outputted from each pixel in the photo acceptance unit 1601, and the voltage value d1 is converted to a digital signal value d2 in the reading circuit 1602. If the binning setting is 2×2, the data operation circuit 1603 summates the signal values of the four hatched pixels, and the value 4×d2 of the summation result is written at a memory position that corresponds to the position of the pixels after pixel aggregation.

The above processing enables a binning process also in sensors other than CCD image sensors, such that data volume can be reduced, in the same way as in the first embodiment, by performing binning setting on the basis of a guessed stain method.

The same effect of the first embodiment can be elicited as well on the basis of the configuration in the above-described second embodiment. That is, a stain method is estimated in a preliminary measurement, so that the volume of data acquired in the main measurement can be reduced, also in cases of batch processing of mixed slides having been treated according to a plurality of stain methods. As a result, this renders unnecessary imaging of data at an excessive resolution, and allows increasing throughput. Also, image data is kept down to an appropriate resolution, which in turn allows enhancing the response speed for display, edition and storage, so that the user can enjoy a friendlier environment.

In the present embodiment, resolution conversion of image data is performed in the data operation circuit 1603, but the same processing can be realized using a program stored in an external storage device and in the CPU 401 in the image processing apparatus 110. Such a configuration lies also within the scope of the present invention.

### Third Embodiment

In the third embodiment an example will be explained wherein, unlike in the first and the second embodiment, data volume is reduced through modification of an image compression parameter in the compression processing S504 in the internal flow of the main measurement processing illustrated in FIG. 4A.

In the present embodiment, a JPEG compression/coding scheme will be explained as an example of an image compression scheme that is used in the compression processing S504. The present embodiment can be used in other compression/coding schemes such as JPEG2000, JPEG-XR and the like, since these are structured similarly to JPEG as regards image conversion processing and quantization processing. (For instance, JPEG2000 utilizes a wavelet transform instead of a discrete cosine transform).

A brief overview of the JPEG compression scheme will be explained first,

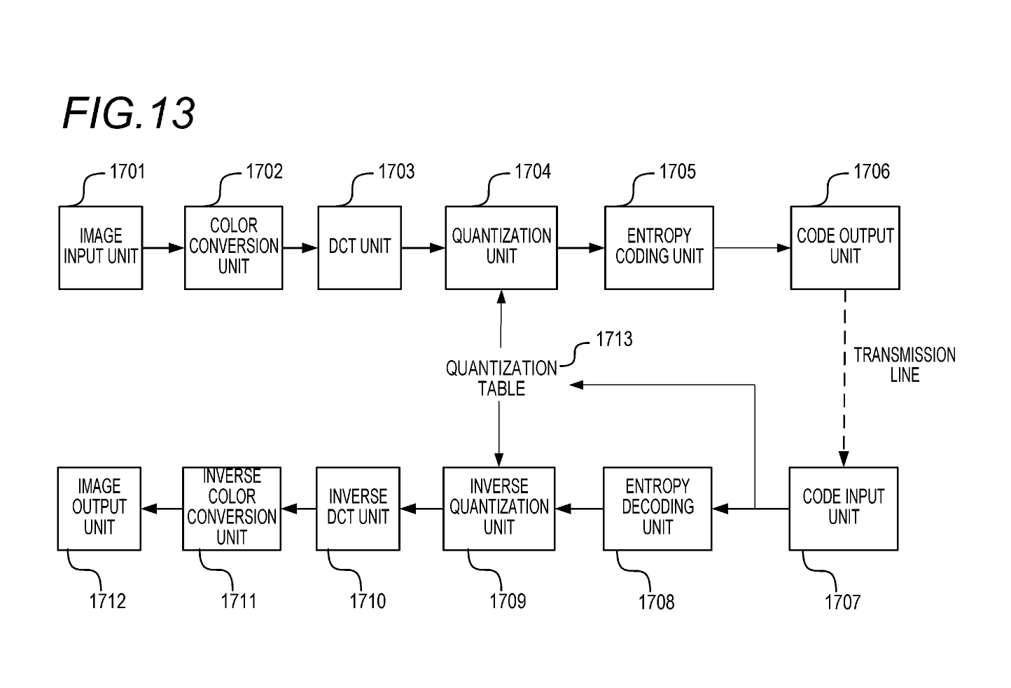

FIG. 13 illustrates a block diagram of a coding and a decoding device of a JPEG compression/coding scheme. The top in FIG. 13 is a block diagram of a JPEG image coding device.

A pixel signal that makes up an image to be coded is inputted into an image input unit 1701, for each minimum coded unit. The output is inputted to a color conversion unit 1702. The color conversion unit 1702 performs color conversion processing wherein, if the inputted image signal has color, the inputted image signal is converted to a color space that is appropriate for compression, for instance YCrCb (brightness color difference) or the like. A prescribed or arbitrary color conversion scheme (color conversion algorithm) can be used for color conversion. In this case, the information in the color conversion scheme used during compression is assigned to compression/coding data, to enable restoration (inverse color conversion) in a decoding device. The output of the color conversion unit 1702 is inputted to a discrete cosine transform unit (DCT unit) 1703.

The DCT unit 1703 performs two-dimensional discrete cosine transform processing on the inputted image signal, and calculates and outputs discrete cosine transform coefficients. The details of the discrete cosine transform are well-known and hence an explanation thereof will be omitted.

Next, a quantization unit 1704 quantizes the inputted coefficients on the basis of a quantization table 1713, and outputs indices for the quantized values. The quantization table 1713 is a factor that determines image quality and compression rate. A difference is calculated between DC components, from among the transform coefficients that are inputted to the quantization unit 1704. This is followed by zigzag scanning, and the result is outputted to a subsequent entropy coding unit 1705.

The entropy coding unit 1705 encodes the inputted discrete cosine transform coefficients after quantization, in accordance with a coding table, and outputs a bit stream. A code output unit 1706 can output a code string, which includes that bit stream, to a code input unit 1707, via a transmission line.

The decoding device that decodes the above-mentioned bit stream is explained next.

The bottom of FIG. 13 is a block diagram illustrating the configuration of a JPEG image decoding device. The reference numeral 1707 denotes a code input unit, 1708 denotes an entropy decoding unit, 1709 denotes an inverse quantization unit, 1710 denotes an inverse discrete cosine transform unit, 1711 denotes an inverse color conversion unit and 1712 denotes an image output unit.

The code string is inputted to the code input unit 1707, and the latter analyzes a header included in the code string, and extracts a parameter necessary for subsequent processing. If necessary, the code input unit 1707 controls the processing flow, or forwards the corresponding parameter to a subsequent processing unit.

The bit stream comprised in the code string is outputted to the entropy decoding unit 1708. The entropy decoding unit 1708 decodes the bit stream and outputs the result. The restored quantization indices are outputted to the inverse quantization unit 1709.

The inverse quantization unit 1709 restores the discrete cosine transform coefficients on the basis of the inputted quantization indices and the quantization table 1713 that is read from the header. The transform coefficients are outputted to the subsequent inverse discrete cosine transform unit 1710.

The inverse discrete cosine transform unit 1710 performs a two-dimensional inverse discrete cosine transform, and calculates a signal of the original image having undergone color conversion, in minimum coded units, on the basis of the transform coefficients. The inverse color conversion unit 1711 performs inverse color conversion on the inputted signal of the original image having undergone color conversion in minimum coded units, and restores the signal of the original image in minimum coded units.

The inverse color conversion unit 1711 performs the above-described processing for all the minimum coded units that make up the original image, to restore the entire original image. The image output unit 1712 outputs the restored image signal.

(Imaging Data Volume Reduction)

Control of a compression parameter depending on the stain method, being a characterizing feature of the present embodiment, is explained next.

As explained above, a comparison between histological diagnosis and cytological diagnosis reveals that histological diagnosis tends to lay less emphasis on resolution than cytological diagnosis. Therefore, the quantization step of high-frequency components in the quantization table may be set more roughly for specimens stained according to stain method used in histological diagnosis, such as HE staining or the like, than is the case of a stain method that is used in cytological diagnosis, for instance Papanicolaou staining or Giemsa staining. As a result there can be reduced the data volume (image data size after compression) of image data as captured during the measurement.

A biased color distribution occurs in stained images. Accordingly, the color conversion scheme is optimized for each stain method, to allocate thereby more bits to biased color components, and fewer bits to other components. The image as a whole can be compressed efficiently as a result.

An example is explained next of a method for deciding a color conversion scheme that enhances a data compression rate using a conventional technique.

In the CbCr plane of YCbCr conversion often used in JPEG compression/coding, yellow (Ye) and blue (B) appear at relatively close positions in the Cb axis. In images of substantial frequency of appearance of yellow (Ye) and blue (B), therefore, image compression can be performed, while preserving image quality, by setting a rough quantization table of spatial frequencies corresponding to the Cr axis, after discrete cosine transform. On the other hand, magenta (Mg) and green (G) appear at central positions of the first quadrant and the third quadrant, respectively, of the CbCr plane. In images of significant frequency of appearance of magenta (Mg) and green (G), thus, there is a limit as to how rough the quantization table of spatial frequencies can be that corresponds to the Cb axis and the Cr axis after discrete cosine, while preserving image quality and the same time.

In such instances, a new Cb′ axis and Cr′ axis may be worked out through transformation of the Cb axis and Cr axis in such a manner that components of substantial frequency of appearance stand on the axes, and the color coordinates are represented on the Cb′Cr′ plane. The appearance coordinates can be biased thereby to either the Cb′ or the Cr′ axis. Also, image compression efficiency is enhanced, while preserving image quality, by way of a rougher quantization table of spatial frequencies corresponding to the Cb′ or Cr′ axis, after discrete cosine transform.

In the color conversion unit 1702, color conversion from the RGB color space to a C1C2C3 color space is represented by the affine transformation (made up of linear transformation and parallel translation) set forth below. (lt1, lt2 and lt3 are parallel translation components)

$$( \begin{matrix}C 1 \\ C 2 \\ C 3 \\ 1\end{matrix} ) = ( \begin{matrix}l 11 & l 12 & l 13 & l t 1 \\ l 21 & l 22 & l 23 & lt 2 \\ l 31 & l 32 & l 33 & l t 3 \\ 0 & 0 & 0 & 1\end{matrix} ) ( \begin{matrix}R \\ G \\ B \\ 1\end{matrix} ) \qquad [ Expression 1 ]$$

A conversion expression from the C1C2C3 color space to a C1′C2′C3′ color space is represented by the expression below, in the form of an affine transformation. (mt1, mt2 and mt3 are parallel translation components)

$$( \begin{matrix}C {1}^{′} \\ C {2}^{′} \\ C {3}^{′} \\ 1\end{matrix} ) = ( \begin{matrix}m 11 & m 12 & m 13 & m t 1 \\ m 21 & m 22 & m 23 & m t 2 \\ m 31 & m 32 & m 33 & mt 3 \\ 0 & 0 & 0 & 1\end{matrix} ) ( \begin{matrix}C 1 \\ C 2 \\ C 3 \\ 1\end{matrix} ) \qquad [ Expression 2 ]$$

Therefore, the conversion expression from the RGB color space to the C1′C2′C3′ color space is as follows.

$$\begin{matrix}( \begin{matrix}C {1}^{′} \\ C {2}^{′} \\ C {3}^{′} \\ 1\end{matrix} ) = ( \begin{matrix}m 11 & m 12 & m 13 & m t 1 \\ m 21 & m 22 & m 23 & mt 2 \\ m 31 & m 32 & m 33 & m t 3 \\ 0 & 0 & 0 & 1\end{matrix} ) ( \begin{matrix}l 11 & l 12 & l 13 & lt 1 \\ l 21 & l 22 & l 23 & lt 2 \\ l 31 & l 32 & l 33 & lt 3 \\ 0 & 0 & 0 & 1\end{matrix} ) \\ ( \begin{matrix}R \\ G \\ B \\ 1\end{matrix} ) \\ = ( \begin{matrix}n 11 & n 12 & n 13 & n t 1 \\ n 21 & n 22 & n 23 & n t 2 \\ n 31 & n 32 & n 33 & n t 3 \\ 0 & 0 & 0 & 1\end{matrix} ) ( \begin{matrix}R \\ G \\ B \\ 1\end{matrix} )\end{matrix} \qquad [ Expression 3 ]$$

To work out values in the RGB color space from the C1′C2′C3′ color space in the inverse color conversion unit 1711, it is sufficient to calculate the inverse matrix of the matrix used by the color conversion unit 1702, and to indicate the information on the inverse matrix in the coding data that is outputted by the code output unit 1706. The information is used by the inverse color conversion unit 1711.

For instance, in a stain method where the frequency of appearance of the abovementioned magenta (Mg) and green (G) is high, firstly CbCr coordinates of two high frequencies of appearance are extracted, from the image data of multiple objects having been stained according to the abovementioned stain method, to determine, on the basis of a YCbCr color space, a color conversion scheme that enables compression of a greater data volume. Straight lines that run through the coordinates are worked out, and respective rotation angles θ between the axes and the straight lines are determined. A conversion expression from the RGB color space to YCb′Cr′ is worked out by calculating an affine transformation matrix on the basis of the rotation angles θ.

An example of color space conversion that affords a higher data compression rate has been explained for the YCbCr color space, but the present embodiment can be used in other color spaces. Accordingly, methods of color space conversion aimed at other color spaces, such as sRGB, Adobe RGB, XYZ, L*a*b*, HSV or the like, lie also within the scope of the present invention.

As explained above, a color conversion scheme and a quantization table mapped to each stain method are held as imaging control information for each stain method, such that the data volume of the main measurement can be reduced through compression/coding of image data using values corresponding to each of the estimated stain methods.

Features in the present embodiment that are different from those of the first and second embodiments will be explained next. In the imaging control information acquisition processing for each stain method S1402 in the present embodiment, a color conversion scheme and quantization table corresponding to the estimated stain method are acquired from imaging control information for each stain method. In the imaging data reduction setting processing S1403, the acquired color conversion scheme and quantization table, as image compression parameters of the compression processing S504 in the main measurement processing, are set as parameters that are used in the color conversion unit 1702 and the quantization unit 1704, respectively. The image data from imaging is compressed, in the main measurement processing S904, using the set color conversion scheme and quantization table. As a result there is reduced the size of image data that is sent to the image processing apparatus in the transmission processing S505, and device throughput is enhanced as a result. The method described in the present embodiment is advantageous in that, unlike in binning described in the first and second embodiments, finer data reduction can be afforded depending on the quantization table that is set.

In the third embodiment described above, the stain method is estimated in a preliminary measurement, and the setting of the image compression processing is selected according to the estimation. As a result, it becomes possible to reduce the volume of data acquired in the main measurement, also in cases of batch processing of mixed slides having been treated according to a plurality of stain methods. In turn, this allows avoiding acquisition of data at an excessive resolution, and allows increasing device throughput. The size of image data is kept small, and hence it becomes possible to increase the response to storage in the storage device 113 and transmission response to the other computer system 114. The user can enjoy thus a friendlier environment.

The present embodiment resorts to a configuration wherein dissimilar compression rates (image quality) are set in accordance with the stain method, but the present invention is not limited thereto. For instance, stained image data for histological diagnosis alone may be compressed, for the purpose of data volume reduction, while other image data may be left uncompressed (or be subjected to lossless compression), in order to prevent degradation of image quality.

### Fourth Embodiment

In the fourth embodiment, imaging magnification changing (switching) processing is added before the imaging data reduction setting processing explained in the first to third embodiments. Doing so elicits the effect of enhancing the results of subsequent data reduction.

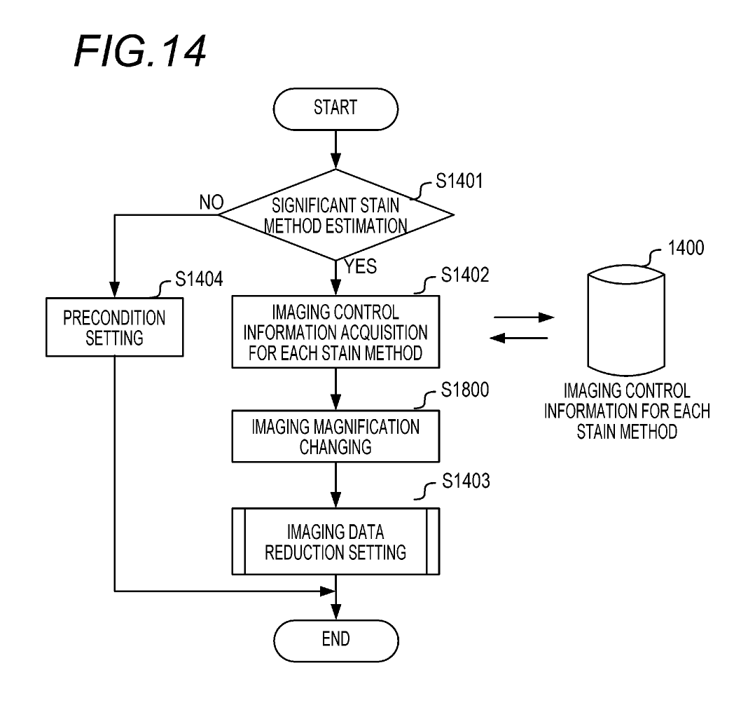

FIG. 14 is a flowchart illustrating the details of the imaging condition setting processing S903 in the fourth embodiment. As characterizing features of the fourth embodiment, the imaging control information for each stain method further includes magnification information on an objective lens of the imaging optical system 205, in addition to the information (binning setting, compression setting and so forth) described in the first to third embodiments; also, imaging magnification changing processing S1800 is further included. The table below gives an example of objective lens magnification information included in the imaging control information. As explained above, histological diagnosis tends to lay less emphasis on resolution than cytological diagnosis. Therefore, the imaging magnifications is set to a lower value for HE staining, which is used in histological diagnosis, than for other stain methods that are used in cytological diagnosis. Other processing S1401 to processing S1404 are substantially identical to those in the first to third embodiments explained in FIG. 10, and hence a detailed explanation thereof will be omitted.

TABLE 3

| Stain method | Objective lens magnifications |
|---|---|
| HE staining | 20x |
| Papanicolaou staining | 40x |
| Giemsa staining | 40x |

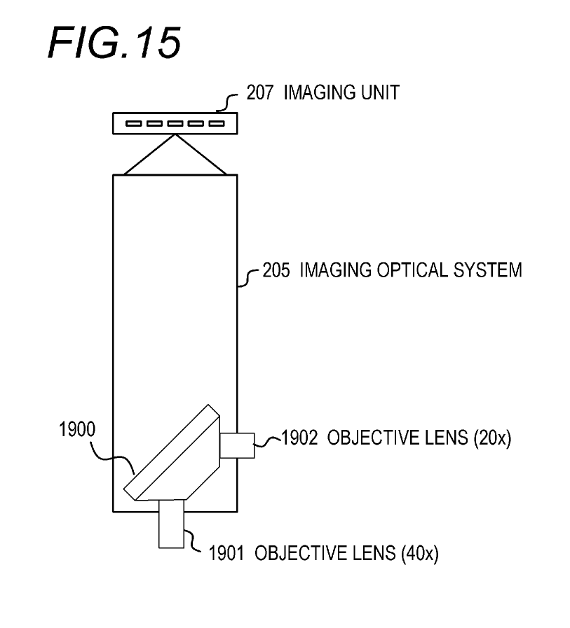

FIG. 15 is a configuration diagram illustrating the structure of the imaging optical system 205 on an object side. A revolver 1900, on which there is mounted a plurality of objective lenses of dissimilar magnifications (a 40× lens 1901 and a 20× lens 1902 in FIG. 15) is fitted to the imaging optical system 205, on the object side. In the virtual slide system of the present embodiment, an instruction of the image processing apparatus 110 is transmitted, via the controller 108, to a revolver control unit, not shown, so that the revolver is caused to rotate as a result to change the magnification of the objective lens.

The focal position may shift upon objective lens exchange. However, focus is adjusted using the AF unit 109 in the main measurement processing S904, and the controller 108, through the stage control 105, causes the stage to move to a focusing position that is appropriate for observation.

Like the first to third embodiments, the fourth embodiment described above elicits the effect of allowing reducing appropriately the volume of image data, in the main measurement, in accordance with the stain method. Through the introduction of the imaging magnification changing processing S1800, the present embodiment further elicits also the effects set forth below.

Firstly, the appearance of the digital image can resemble as closely as possible the appearance of observation images of an optical microscope, with which a pathologist, as the user, is more familiar. Typical examples of parameters that influence the appearance of images include, for instance, depth of field, blur and so forth. For a user that relies on diagnosis using a optical microscope concomitantly with diagnosis relying on a virtual slide system, it is easier to compare images viewed under an optical microscope and under a virtual slide system if the depth of field and blur in the virtual slide system resemble those in the optical performance of the optical microscope. Therefore, the convenience for diagnosis of the virtual slide system can be further enhanced by setting the imaging magnifications for each stain method in the imaging control information in accordance with the magnifications for diagnosis when using an optical microscope.

Also, the data reduction performance can be enhanced by performing imaging at low magnifications in the case of HE staining. For instance, the lower the lens magnification that is set, the smaller becomes high-frequency components in the image. This allows enhancing, as a result, the data reduction performance (compression rate) in the image data compression processing. Reducing high-frequency components in the image has the effect of suppressing aliasing (aliasing distortion) that occurs through sampling across pixels in the above-described binning process of the first and second embodiments.

### Fifth Embodiment

In the first to fourth embodiments, the stain method is estimated using an image obtained in a preliminary measurement, but the stain method may be estimated using other information items. In the fifth embodiment a method for reducing data volume is explained in which the stain method is estimated on the basis of an image other than the image calculated in the preliminary measurement. The preliminary measurement unit is not necessary when using the method of the present embodiment.

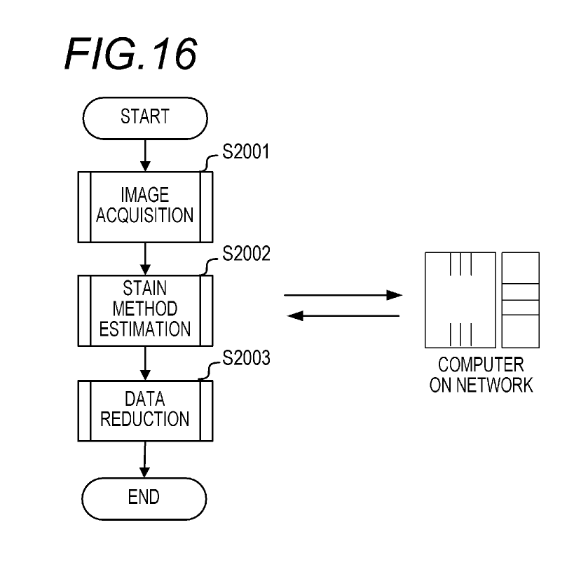

FIG. 16 is a flowchart illustrating an internal processing flow of stain method estimation control processing in the present embodiment. The various steps of FIG. 16 are explained below.

In image acquisition processing S2001, the image processing apparatus 110 acquires an image that is used to estimate the stain method. There are two acquisition methods, namely a method of acquiring imaging data from the main measurement unit 101, and a method of acquiring an image data file that results from imaging already performed in another imaging device and that is stored with a predetermined image format. Either method may be used. If the latter method is used, the image processing apparatus 110 can acquire the image data file, for instance, from the other computer system 114 illustrated in FIG. 1, through a network, or can read the file from the storage device 113.

Next, in stain method estimation processing S2002, the image processing apparatus 110 analyzes the image data acquired in S2001, and estimates the stain method that has been applied to the object in the image data. The specific estimation processing is identical to that in the first to fourth embodiments explained above.

If the image data acquired in S2001 is image data of high definition and large data size, as is the image data resulting from imaging by the main measurement unit 101, then the estimation processing of the stain method may be performed using data of a low-resolution reduced image, and not of the original size. That is because in order to estimate the stain method, the image data need not have that much definition, and therefore it is desirable to increase processing speed through reduction of data volume.

Specifically, a low-resolution reduced image may be created through resolution conversion. Any method may be used as the resolution conversion method, for instance, a method wherein a low-resolution image of size 1/m is created through averaging over m×m pixel block units, or a method in which a low-resolution image is created through interpolation, for instance bicubic, bilinear or nearest neighbor interpolation. Some image file formats may be structured to store image data of a plurality of sizes, for high-speed display, for instance a reduced image (thumbnail image), or an image having half the size or ¼ the size of the original image. In the case of images having such file formats, the image processing apparatus 110 may extract a low-resolution reduced image that is present in the file, and use the reduced image for stain method estimation.

Processing in the stain method estimation processing S2002 may be carried out by a computer on a network. In this case, the low-resolution image data is calculated or extracted by the image processing apparatus 110, and the image is sent to the computer on the network. Next, the computer on the network estimates the stain method, and sends the estimation results to the image processing apparatus 110.

The image processing apparatus 110 may execute processing up to the histogram generation processing S1102 (FIG. 7B), and send the result to the computer on the network, whereupon the computer on the network executes the processing from the matching calculation processing S1103 onwards. In this method, the image data itself need not be transmitted, and hence the communication time can be shortened.

Next, in data reduction processing S2003, the image processing apparatus 110 reduces the data volume of the image data according to the stain method estimated in the stain method estimation processing S2002.

A procedure similar to that of the first to third embodiments can be used in a case where image data resulting from imaging using the main measurement unit 101 is inputted in the image acquisition processing S2001. That is, the image processing apparatus 110 refers to a combination of binning setting or color conversion scheme plus quantization table, set for each stain method, and, in accordance with those settings (as the case may require), executes resolution conversion processing or compression processing on the image data acquired in S2001. For instance, image data corresponding to 20× optical magnifications is deemed to suffice for histological diagnosis. In a case where the imaging magnifications of image data acquired in S2001 is 40×, and the stain method estimated in S2002 is HE staining, then the image processing apparatus 110 may aggregate 2×2 pixels into 1 pixel, through digital image processing (this corresponds to the binning process in the first and second embodiments), to reduce thereby data volume.

In a case where, in the image acquisition processing S2001, image data is read from the storage device 113 or the other computer system 114, the image processing apparatus 110 may decide the data volume reduction method in accordance with the file format of the image data.

In a case of, for instance, an image having a file format that holds image data of a plurality of sizes, a similar data volume reduction effect can be achieved by deleting some data in the file. For instance, the image data file may contain images in four types of resolution, namely a same-size image (magnification corresponding to 40×), a ½ image (magnification corresponding to 20×), a ¼ image (magnification corresponding to 10×), and a 1/10 image (magnification corresponding to 4×). If the estimated stain method is HE staining, image data of unnecessary resolution (in this case, the same-size image data) may be deleted, to enable thereby significant data volume reduction. This method requires no resolution conversion, and incurs therefore no computational load, which is advantageous.

In another conceivable example, the image data file may be a JPEG2000 compression/coding scheme. In JPEG2000, image data is subjected to a discrete wavelet transform during compression/coding, the image is decomposed into four bands (LL, LH, HL, HH), and the image in the lowest band LL is recursively decomposed according to the same operation. During decoding, conversely, the image is synthesized recursively form the lowest band LL; as a result, a high resolution image can be gradually restored from a low-resolution image. Accordingly, the coding data for the LH, HL, HH bands is deleted in a case where the original image data, having a resolution corresponding to 40×, is reduced to a resolution corresponding to 20×. Doing so allows reducing data volume efficiently, without incurring image quality degradation in the lowest band LL. After deletion of some data, there is updated the information that denotes the file configuration, for instance header information, to preserve file integrity.

Data can thus be reduced efficiently, in accordance with the stain method and image format, also for image data files that are stored with a predetermined image format.

As described in the first to fifth embodiments above, the data volume of image data is appropriately reduced in accordance with the result of a stain method estimation. As a result, it becomes possible to avoid acquisition of data at excessive resolution, and to increase device throughput as well as response for data transmission, storage, edition and browsing, thereby affording greater convenience for the user.

The features in the first to fifth embodiments are merely specific examples of the present invention, and various configurations other than those of the embodiments can be used in the present invention. For instance, the database that stores the imaging control information may be on a network server, instead of in the external storage device of the image processing apparatus 110. Also, the imaging control information can be set to identical values for each location (hospital, business, academic institution, analysis center and other facilities), and a physician, as the user, may set the imaging control information for each batch processing.

In the first embodiment an example has been explained wherein a binning process of charge addition is performed to reduce data volume upon reading of charge accumulated in each pixel of a CCD image sensor, but the same configuration can be used in a passive-type CMOS sensor having no pixel unit amplification function. Therefore, the feature of changing the binning setting in accordance with the stain method lies also within the scope of the present invention, regardless of the type of the CCD or the CMOS sensor.

The data reduction effect can be reinforced by combining the configurations explained for the respective embodiments. For instance, the binning process in the first and second embodiments may be combined with the compression processing of the third embodiment, or the compression processing of the third embodiment may be combined with the imaging magnification changing of the fourth embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-113963, filed on May 20, 2011, which is hereby incorporated by reference herein in its entirety.

What is claimed is:

1. An imaging system that acquires image data through imaging of an object, comprising:
an imaging unit having an imaging optical system that forms an image of an object, and an imaging device that captures the image of the object formed by the imaging optical system;
a stain method estimation unit that estimates a stain method of the object by analyzing image data of the object as obtained from the imaging unit; and
a data reduction processing unit that reduces data volume of image data of the object through lowering of the resolution of the image data, if the stain method estimated by the stain method estimation unit is a predetermined stain method.

2. The imaging system according to claim 1,
wherein the predetermined stain method is a stain method used for staining an object for histological diagnosis.

3. The imaging system according to claim 1,
wherein the imaging device has an image sensor, and
the data reduction processing unit lowers the resolution of image data that is read from the imaging device through a binning process where charges of a plurality of pixels of the image sensor are aggregated and read as information of one pixel.

4. The imaging system according to claim 1,
wherein the data reduction processing unit lowers the resolution of image data read from the imaging device by performing resolution conversion processing on the image data.

5. An imaging system that acquires image data through imaging of an object, comprising:
an imaging unit having an imaging optical system that forms an image of an object, and an imaging device that captures the image of the object formed by the imaging optical system;
a stain method estimation unit that estimates a stain method of the object by analyzing image data of the object as obtained from the imaging unit; and
a data reduction processing unit that reduces data volume of image data of the object if the stain method estimated by the stain method estimation unit is a predetermined stain method,
wherein the data reduction processing unit includes a compression unit that compresses image data obtained from the imaging unit.

6. The imaging system according to claim 5,
wherein the compression unit increases a compression rate of image data of an object, the stain method of which has been estimated to be the predetermined stain method, to be higher than a compression rate of image data of another object.

7. The imaging system according to claim 5,
wherein the compression unit includes a color conversion unit that converts a color space of the image data in order to increase a compression rate, and
the color conversion unit changes a color conversion scheme in accordance with the stain method estimated by the stain method estimation unit.

8. An imaging system that acquires image data through imaging of an object, comprising:
an imaging unit having an imaging optical system that forms an image of an object, and an imaging device that captures the image of the object formed by the imaging optical system;
a stain method estimation unit that estimates a stain method of the object by analyzing image data of the object as obtained from the imaging unit; and
a data reduction processing unit that reduces data volume of image data of the object if the stain method estimated by the stain method estimation unit is a predetermined stain method,
wherein the imaging unit has a first imaging unit and a second imaging unit that performs imaging at a higher definition than the first imaging unit,
the stain method estimation unit estimates a stain method using image data obtained from the first imaging unit, and
the data reduction processing unit reduces data volume of image data obtained from the second imaging unit.

9. The imaging system according to claim 8,
wherein the second imaging unit has an imaging optical system in which magnifications can be changed, and the magnifications of the imaging optical system are set to be lower upon imaging of an object the stain method of which has been estimated to be the predetermined stain method, than upon imaging of another object.

10. An image processing apparatus that processes image data of an object, comprising:
an image acquisition unit that acquires image data of an object;
a stain method estimation unit that estimates a stain method of the object by analyzing image data of the object as acquired by the image acquisition unit; and
a data reduction processing unit that reduces data volume of image data of the object through lowering of the resolution of the image data, if the stain method estimated by the stain method estimation unit is a predetermined stain method.

11. An image processing apparatus that processes image data of an object, comprising:
an image acquisition unit that acquires image data of an object;
a stain method estimation unit that estimates a stain method of the object by analyzing image data of the object as acquired by the image acquisition unit; and
a data reduction processing unit that reduces data volume of image data of the object if the stain method estimated by the stain method estimation unit is a predetermined stain method,
wherein the stain method estimation unit estimates a stain method using data of a reduced image of the image data acquired by the image acquisition unit.

12. The image processing apparatus according to claim 10,
wherein the data reduction processing unit lowers the resolution of image data acquired by the image acquisition unit by performing resolution conversion processing on the image data.

13. An image processing apparatus that processes image data of an object, comprising:
an image acquisition unit that acquires image data of an object;
a stain method estimation unit that estimates a stain method of the object by analyzing image data of the object as acquired by the image acquisition unit; and
a data reduction processing unit that reduces data volume of image data of the object if the stain method estimated by the stain method estimation unit is a predetermined stain method,
wherein the data reduction processing unit includes a compression unit that compresses image data acquired by the image acquisition unit.

14. The image processing apparatus according to claim 13,
wherein the compression unit increases a compression rate of image data of an object, the stain method of which has been estimated to be the predetermined stain method, to be higher than a compression rate of image data of another object.

15. The image processing apparatus according to claim 13,
wherein the compression unit includes a color conversion unit that converts a color space of the image data in order to increase a compression rate, and
the color conversion unit changes a color conversion scheme in accordance with the stain method estimated by the stain method estimation unit.

16. An image processing apparatus that processes image data of an object, comprising:
an image acquisition unit that acquires image data of an object;
a stain method estimation unit that estimates a stain method of the object by analyzing image data of the object as acquired by the image acquisition unit; and
a data reduction processing unit that reduces data volume of image data of the object if the stain method estimated by the stain method estimation unit is a predetermined stain method,
wherein the data reduction processing unit decides a reduction method of data volume in accordance with a file format of image data acquired by the image acquisition unit.

17. A computer program stored on a non-transitory computer readable medium, the program causing a computer to perform a method comprising the steps of:
acquiring image data of an object;
estimating a stain method of the object by analyzing the acquired image data of the object; and
reducing data volume of image data of the object through lowering of the resolution of the image data, if the estimated stain method is a predetermined stain method.

18. A computer program stored on a non-transitory computer readable medium, the program causing a computer to perform a method comprising the steps of:
acquiring image data of an object;
estimating a stain method of the object by analyzing the acquired image data of the object; and
reducing data volume of image data of the object if the estimated stain method is a predetermined stain method, wherein
in the estimation step, the stain method is estimated using data of a reduced image of the image data.

19. A computer program stored on a non-transitory computer readable medium, the program causing a computer to perform a method comprising the steps of:
acquiring image data of an object;
estimating a stain method of the object by analyzing the acquired image data of the object; and
reducing data volume of image data of the object if the estimated stain method is a predetermined stain method, wherein
the reduction step includes a step of compressing the image data.

20. A computer program stored on a non-transitory computer readable medium, the program causing a computer to perform a method comprising the steps of:
acquiring image data of an object;
estimating a stain method of the object by analyzing the acquired image data of the object; and
reducing data volume of image data of the object if the estimated stain method is a predetermined stain method, wherein
in the reduction step, a reduction method of data volume is decided in accordance with a file format of the image data.
